(19) United States
(12) Patent Application Publication
(10) Pub. No.: US 2017/0089012 A1
(43) Pub. Date: Mar. 30, 2017

(54) Security element against counterfeiting security printing, especially banknotes

(71) Applicant: Piotr NAWROCKI, Inowroclaw (PL)

(72) Inventor: Piotr NAWROCKI, Inowroclaw (PL)

(21) Appl. No.: 14/864,578

(22) Filed: Sep. 24, 2015

(51) Int. Cl. D21H 21/48; G07D 7/12; B42D 25/36

(52) U.S. Cl. CPC D21H 21/48; B42D 25/36; G07D 7/122

(57) ABSTRACT

The present invention is a security feature against counterfeiting security printing, in particular banknotes, having at least one graphene quantum dot (GQD) that has a graphene nanoparticle diameter ranging from 0.5 nm to 60 nm, and containing from 1 to 90 layers of graphene disposed in the flexible layer of graphene nanocomposite material, where the elastic layer of graphene nanocomposite material comprises at least one layer of graphene arranged on the adhesive layer. The invention also includes the use of the security feature according to the invention, and a method and system for verifying the authenticity of security printing.

### FIELD OF THE INVENTION

The invention relates to a chip that protects against counterfeiting security printing, especially for banknotes and other security printing (e.g. pre-numbered forms), enabling the verification of the authenticity of a document.

### BACKGROUND OF THE INVENTION

Security printing is a type of printing, the execution of which by unauthorised persons is hampered by deliberate application of safeguards by which the safety of legitimate users is ensured. Used securities in varying degrees can protect against certain forms of counterfeiting. Securities, banknotes or important documents sometimes have a number of different security features difficult enough to falsify so that they are called highly protected prints.

There are three levels of security:
a) the first degree—security based on organoleptic properties—for users without tools,
b) the second degree—securities verified using basic tools, e.g. magnifying glass, or UV lamp,
c) the third degree—security verified by experts (specialists) in appropriately equipped laboratories.

Banknotes have securities to protect against counterfeiting and thus belong to the group of security printing. The most widely used securities are:
special, secret recipe paper conferring specific mechanical and optical properties;
replacing paper with apolymer substrate difficult to print on;
use of microprinting;
recto-verso, which is a picture visible in the lumen, created with the finely fitting elements located on both sides of a banknote.
a description on the recto;
hot-stamping foil with a metallic holographic pattern;
embossment resulting from intaglio printing;
complex graphics, yet distinct, with strong saturation and gloss paint;
watermark, especially visible against visible light;
a security thread in the form of a metal strip recessed inwardly in paper with spacing forming an inscription;
printing with an optically variable ink—seen in front and at a sharp angle it changes colour;
ribbing; and
drawings visible under UV light.

In addition, part of banknote security is kept secret and is a strict secret data of the central banks issuing banknotes.

Due to the continuous development of counterfeiting techniques a constant search for new methods of document protection against illegal copying is needed. The aim of the present invention is therefore to provide a new kind of security.

These and other features and advantages of the present invention will be appreciated from review of the following Detailed Description of the Preferred Embodiments, along with the accompanying figures in which like reference numerals are used to describe the same, similar or corresponding parts in the several views of the drawings.

### BRIEF DESCRIPTION OF THE DRAWINGS

FIG. 1 illustrates examples of radiation absorption across the light spectrum;

FIG. 2 illustrates examples of manufacturing methods of graphene quantum dots;

FIG. 3 is a pattern made of graphene quantum dots (GODs) on a flexible substrate;

FIG. 4 are examples of different settings of GQDs nanolayers in an elastic nanocomposite layer; and

FIG. 5 illustrates an operating principle of an inherent security feature.

It will be recognized that some or all of the Figures are schematic representations for purposes of illustration and do not necessarily depict the actual relative sizes or locations of the elements shown. The Figures are provided for the purpose of illustrating one or more embodiments of the invention with the explicit understanding that they will not be used to limit the scope or the meaning of the claims.

### DETAILED DESCRIPTION OF THE PREFERRED EMBODIMENTS

This objective was achieved through the use of graphene quantum dots (Graphene Quantum Dot, GQD).

Quantum dots (QD) are semiconductor nanocrystals with sizes ranging from 2-10 nanometers (“nm”). They are a very specific type of substance with properties intermediate between semiconductors and quantum particles. A limited number of atoms and a diameter of a few nanometres gives the quantum dots unique properties of absorption and emission of radiation, which result from the presence of the effect of the quantum limit (quantum confinement effect). This means that the excitation energy emitted by the photons will depend on the composition of the crystal and its size. Similar to semiconductors, quantum dots absorb photons of light with such energy that the ability to transfer electrons from a non-activated state to a state of a higher available energy level. In addition, there is an emission process, because the wavelength emitted by light depends on the size of the dots. Hence, having a semiconductive material can produce markers having different colours, which are characteristic of quantum dots.

Nanoparticles with a small diameter core (2 nm) have fluorescence at a wavelength corresponding to blue light and even ultraviolet radiation (UV). When the diameter of the quantum dot core increases, the wavelength of the radiation emitted by the visible light increases, up to infrared radiation (IR). By modifying the composition and choosing the size of the nanocrystals, fluorescence in the full spectrum from ultraviolet (UV) to the infrared (IR) is obtained.

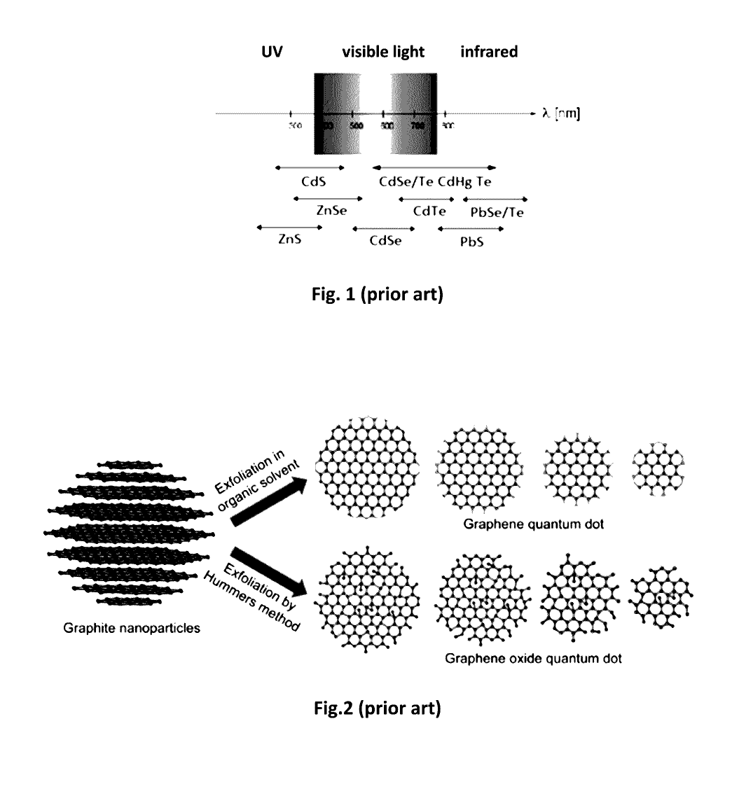

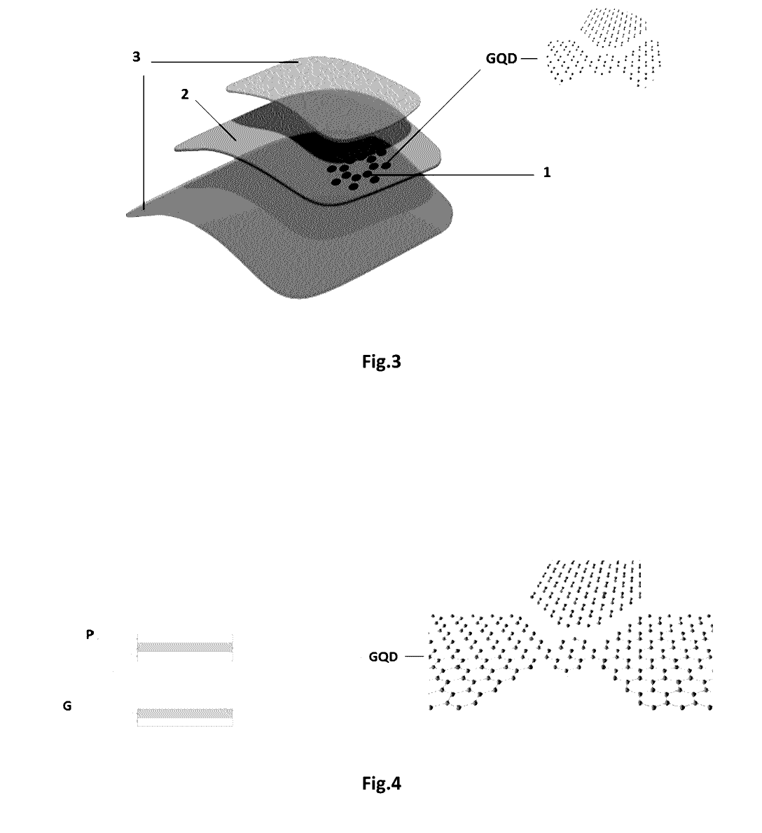

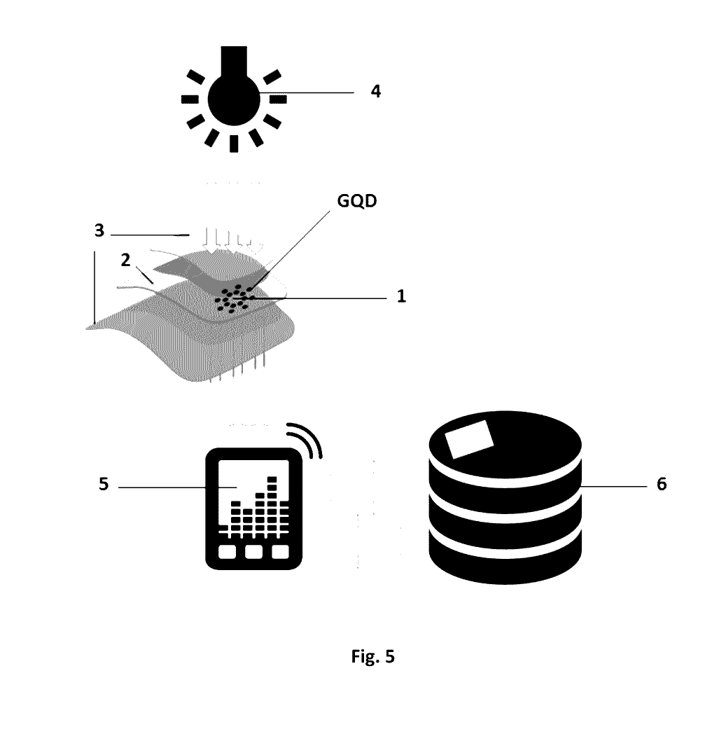

The radiation may be absorbed by quantum dots in a broad spectrum (FIG. 1), and their molar absorption coefficient increases towards the UV. Thus the excitation can be made of many kinds of dots using one light source, since there is no requirement to apply excitation at a pre-set wavelength. In turn, the profile of the fluorescence emission of quantum dots is narrow and has a small half-width value (FWHM 125 nm). This allows for simultaneous use of multiple markers having different colours without fear of overlapping of the signals. The nanocrystals can be repeatedly excited, with no noticeable decrease in fluorescence because they have a high quantum yield of fluorescence and long radiation (10-100 nanoseconds).

Graphene quantum dots (GQD) can also be prepared from graphite carbon fibers. This was successfully done with acids and chemical exfoliation (FIG. 2). By varying the process parameters a whole family of graphene quantum dots the size of the order of 1-4 nm can be made. It should be noted that the optical properties of the dots (quantum confinement effect) depend directly on their size, i.e. the colour of photoluminescence. The resulting structures are two-dimensional, so in fact they produce graphene quantum discs.

Graphene quantum dots are stable because the level of luminescence (that is, they are resistant to photobleaching).

The invention relates to a security element against counterfeiting, in particular banknotes, comprising at least one graphene quantum dot (GQD) that is a graphene nanoparticle with a diameter of from 0.5 nm to 60 nm, preferably from 1 nm to 11 nm, containing from 1 to 90, preferably from 1 to 20 layers of graphene disposed in the flexible layer of graphene nanocomposite material, wherein the elastic layer of graphene nanocomposite material comprises at least one graphene layer disposed on the adhesive layer, preferably a polymer.

Preferably, the security element comprises graphene quantum dots (GQDs) of different sizes.

Preferably at least one quantum dot (GQD), preferably all quantum dots (GQDs) are an integral part of the flexible layer of graphene nanocomposite material.

Graphene in the security element is in a pure or doped form.

Preferably, the security feature comprises a layer of graphene, and two adhesive layers, wherein the graphene layer is located directly between the two layers of adhesive.

The invention also includes the use of the security feature according to the invention for securing banknotes, holograms, documents, passports, credit cards, excise bands, excise forms, personal identifiers, certificates or product labels.

The invention is further a system for checking the authenticity of security printing, in particular banknotes, comprising:
the security element according to the invention,
A device adapted to emit radiation in the range suitable for excitation of at least one graphene quantum dot (GQD), preferably all of the graphene quantum dots (GQDs) contained in the security element, and
A detector adapted to detect luminescence radiation of at least one graphene quantum dot (GQD), and preferably all of the graphene quantum dots (GQDs) contained in the security element.

The invention also applies to a method for checking the authenticity of security printing, in particular banknotes, characterized in that the system is used according to the invention.

The security feature is made of nanocomposite, one of whose components is a binder, preferably a polymer, which ensures its integrity, hardness, flexibility and resistance to compression, and the other is the second layer of plotted quantum dots (GQDs). Flexible nanocomposite material is a material of heterogeneous structure composed of two or more components with different properties. The properties of the composites are not the sum or average of the properties of its components, and the material used in its construction exhibits anisotropy of physical properties.

The security feature is made of a composite material resistant to:
moisture and condensation
splashing
water-damage
corrosion
dust
multiple deformation
changes in temperature in the range −40° C. to +70° C.

The mere presence of the structure of the graphene in a protected document is an additional security factor, as commercial production of graphene in the form of a single structure is not yet available to potential counterfeiters.

A security feature is one of the layers of security printing (3). The security feature (1) in the above example is not an integral part of other securities and may, but does not need to be placed in the same layer as other securities such as a hologram.

The presented security is a separate solution, not interfering directly with any other group of the above mentioned securities.

The security feature (1) based on the modification technology is not limited by current layout, shape and size. It does not require a constant power source. But dedicated devices by which detection is carried out (5) require it.

The structure of the nanocomposite material (2) of the security feature (1) takes into account:
the use of a variable number of layers of polymer (P) in the material—the number of coats applied is dependent on the conditions in which the security element will operate.
The use of a variable number and size of the graphene quantum dots (GQD), if the use such structure gives is necessary to increase the efficiency of the security feature (1).

### The Operation of GQD Security Feature

Security feature (1) designed with quantum dots (GQDs) will be unique for each security printing (3). After treatment with a source of radiation (4), it starts to emit light in adequate band characteristics. The luminescent effect will then be identified by the assigned detection device (5), verified and compared with the standard base (6), followed by a confirmation or denial of compliance.

### Examples of Application of the Security Chip

Other examples of the use of the security chip (1) are authentication of pre-numbered documents, such as:
a passport—the chip is an integral part of the cover;
payment cards—the top layer of the card;
other documents in the form of a payment card, such as a driving license, or ID card;
excise bands and prints;
personal identifiers;
license forms, certificates, etc.;
labels for products with high value and at risk of counterfeiting;

What is claimed is:

1. A security feature device, comprising:
at least one graphene quantum dot (GQD) comprising a graphene nanoparticle with a diameter ranging from 0.5 nanometers to 60 nanometers, and including from 1 to 90 layers of graphene disposed in a flexible layer of graphene nanocomposite material, wherein an elastic layer of graphene nanocomposite material comprises at least one graphene layer disposed on an adhesive layer.

2. The security feature device according to claim 1, comprising graphene quantum dots (GQDs) of different sizes.

3. The security feature device according to claim 1, wherein at least one quantum dot (GQD) is a part of the flexible layer of graphene nanocomposite material.

4. The security feature device according to claim 1, wherein the graphene is present in a pure or a doped form.

5. The security feature device according to claim 1, comprising a layer of the graphene nanocomposite material and two layers of the adhesive, where the graphene layer is located between the two layers of adhesive.

6. The security feature device according to claim 1, where the security feature device is employed in a security group, the security group selected from the group consisting of: a banknote, a hologram, a document, a passport, a credit card, an excise band, an excise form, a personal identifier, a certificate, a product label, and a combination of two or more thereof.

7. A system for checking an authenticity of a security printing, comprising:
a security feature comprising at least one graphene quantum dot (GQD) comprising a graphene nanoparticle with a diameter ranging from 0.5 nanometers to 60 nanometers, and including from 1 to 90 layers of graphene disposed in a flexible layer of graphene nanocomposite material, wherein an elastic layer of graphene nanocomposite material comprises at least one graphene layer disposed on an adhesive layer;
a device adapted to emit a radiation in a range suitable for excitation of at least one graphene quantum dot (GQD) contained in a security element; and
a detector adapted to detect a luminescence radiation of at least one graphene quantum dot (GQD) contained in the security element.

8. A method of verifying an authenticity of a security printing, the method comprising the steps of:
providing a security element comprising at least one graphene quantum dot (GQD) comprising a graphene nanoparticle with a diameter ranging from 0.5 nanometers to 60 nanometers, and including from 1 to 90 layers of graphene disposed in a flexible layer of graphene nanocomposite material, wherein an elastic layer of graphene nanocomposite material comprises at least one graphene layer disposed on an adhesive layer;
a device adapted to emit a radiation in a range suitable for excitation of at least one graphene quantum dot (GQD) contained in the security element; and
a detector adapted to detect a luminescence radiation of at least one graphene quantum dot (GQD) contained in the security element.
